(19) United States
(12) Patent Application Publication
(10) Pub. No.: US 2005/0042767 A1
(43) Pub. Date: Feb. 24, 2005

(54) Method and device for preparing sample slide

(75) Inventors: Hiroshi Machida, Funabashi-shi Chiba (JP); Tsutomu Kojima, Funabashi-shi Chiba (JP); Tomoko Nagaoka, Funabashi-shi Chiba (JP)

Correspondence Address: KODA & ANDROLIA, 2029 CENTURY PARK EAST, SUITE 1430, LOS ANGELES, CA, 90067-3024, US

(73) Assignee: Adscience Technologies Co.

(21) Appl. No.: 10/498,412

(22) PCT Filed: Oct. 4, 2002
(86) PCT No.: PCT/JP02/10352

(30) Foreign Application Priority Data
Dec. 10, 2001 (JP) 2001-376018

(51) Int. Cl. G01N 1/00

(52) U.S. Cl. 436/174; 422/100

(57) ABSTRACT

A method for preparing a sample slide, characterized in that a liquid containing a cell floating therein is fixed under an atmosphere for extension wherein an index of dryness as a control parameter in the preparation of a sample slide foe a material to be tasted is adjusted at a level such that the optimum condition is achieved for the preparing of a sample slide.

### FIELD OF THE INVENTION

The present invention relates to a method and a device for preparing a sample slide of a cell or a chromosome by fixing said analyte on the sample slide. More particularly, the present invention relates to a method and a device for preparing a sample slide displaying a metaphase in an appropriate shape with a predetermined spreading. The present invention is useful in preparing a sample slide of a nucleated cell.

### BACKGROUND ART

Generally, a procedure of chromosome inspection may consist from five stages: cell culture (first step); harvest of cell and preparation of chromosome sample slide (second step); staining of chromosome bands by differential staining technique (third step); microphotography (fourth step); and karyotype analysis (fifth step). The present invention mainly focuses on the harvest of the cell and the preparation of the chromosome sample slide in the second step.

For the harvest of the cell and the preparation of the chromosome sample slide in the second step, the culture cell obtained in the first step is treated with colcemid to give a metaphase cell. Then, the metaphase cell is subjected to hypotonic treatment and physical shock to destroy the cell membrane and the nuclear membrane, thereby spreading out the chromosome present in the spherical nuclear on a glass slide. Thus, there is a need for preparing a sample slide displaying the metaphase in an appropriate shape with a predetermined spreading. If the sample slide does not come out clear, the subsequent processes such as the chromosome band staining becomes noticeably difficult.

Specifically, according to a conventional technique for preparing a chromosome sample slide, a cell-floating fluid containing chromosome is manually dropped on a slide to spread and fix the chromosome present in the spherical nuclear on the glass slide. In other words, according to the conventional technique for preparing a chromosome sample slide, each of the steps of the fixing technique greatly depends on the skill of the technician.

Examples of the manual technique are shown in FIGS. 19 to 22. According to a flame fixing technique shown in FIG. 19, a drop 4 of a cell-floating fluid 3 from a pipette 2 is spread out on a sample slide (glass slide) 1. Then, the sample slide 1 is quickly passed through the flame of a burner 5 to set fire to methanol for evaporating the liquid mass from the cell-floating fluid 3, thereby preparing a sample.

According to a steam fixing technique shown in FIG. 20, a sample slide 1 prepared by dropping a cell-floating fluid 3 as shown in FIG. 19 is placed close to steam 8 evaporating from a container 7 heated with a heater 6 so that the liquid mass of the cell-floating fluid 3 is evaporated, thereby preparing a sample.

According to a fixing technique at a high temperature and a high humidity shown in FIG. 21, a glass slide 1a is placed in a high-temperature and high-humidity environment provided by a wet paper towel 10 heated with a hot plate 9 and a cell-floating fluid 3 is dropped 4 and spread on the glass slide 1a in the same manner as the technique shown in FIG. 19 so that a sample is prepared by evaporating the liquid mass of the cell-floating fluid 3.

Furthermore, according to a fixing technique at room temperature by dropping from a high altitude as shown in FIG. 22, a cell-floating fluid 3 is dropped 4 from a height of several millimeters or sometimes about 1.5 meters to be spread out on a glass slide 1a seated on a working table and the liquid mass of the cell-floating fluid 3 is evaporated, thereby preparing a sample.

The above-described techniques require a certain skill to give a metaphase of chromosome in the cell-floating fluid 3 in an appropriate shape. Moreover, each technique is somehow established upon contingent incidents, rendering it difficult to prepare uniform sample slides. Thus, not anyone is able carry out these techniques. In other words, optimal conditions for obtaining fixation suitable as an analyte are not ruled for these techniques and therefore fixation depends on empirical knowledge of the practitioner.

Needless to say, according to the above-described conventional skill-required techniques for preparing a sample slide, it is difficult for an inexperienced practitioner to prepare a sample slide of a metaphase chromosome in an appropriate shape as a sample. In addition, these conventional techniques are poor in reproducibility of the operation conditions and in quality stability due to manual procedures by the practitioner.

In view of the above-described problems, the present invention has an objective of providing a method feasible for everyone for preparing a sample slide suitable as an analyte by controlling dryness, a parameter involved in the sample slide preparing method and an objective of providing a device for preparing a sample slide with stable quality and furthermore allowing mass production of the sample slide.

### DISCLOSURE OF THE INVENTION

The present inventors have gone through studies in order to achieve the above-mentioned objectives and found that a metaphase in an appropriate shape can be prepared by drying a liquid analyte in an appropriate drying environment, thereby accomplishing the present invention.

According to the method for preparing a sample slide of the invention, a cell-floating fluid is fixed in a spreading environment where dryness, a control parameter of sample slide preparation, is adjusted so as to obtain optimal conditions for preparing the sample slide.

Furthermore, the dryness is obtained by providing a temperature and humidity sensors in the spreading environment for the cell-floating fluid to measure the temperature and the humidity within the spreading environment, obtaining a saturated moisture value at the said temperature and, based on this saturated moisture value and the actual absolute humidity, calculating according to the following equation:
Dryness [Idry]=Saturated moisture [Ws]−Absolute humidity [AbsH].

The device for preparing the sample slide of the invention where an analyte of a cell or a chromosome is fixed thereon is provided with a mechanism for controlling the dryness of the environment for spreading the metaphase analyte on the sample slide.

The mechanism for controlling the dryness measures the temperature and the humidity in the cell-floating fluid spreading environment with the temperature and humidity sensors arranged in the environment, obtain the saturated moisture value at the said temperature and, calculate the dryness based on this saturated moisture value and the actual absolute humidity.

The device for preparing the sample slide is further provided with a mechanism for preparing a liquid analyte for obtaining a liquid analyte to be added onto the sample slide dropwise.

According to the method and the device for preparing a sample slide, anyone can prepare a sample slide with optimal cell or chromosome fixing by controlling, among the control parameters for optimal fixing of the analyte on the sample slide, the dryness of the dropped cell-floating fluid.

The present invention further has an advantage of allowing automated preparation of a quality stable sample slide, enabling mass-production thereof.

### BRIEF DESCRIPTION OF THE DRAWINGS

FIG. 1 is a block diagram showing measurement of dryness according to a method for preparing a sample slide of the invention;

FIG. 2 is a schematic view illustrating the relationship between the dryness and the spreading of cell;

FIG. 3 is a schematic view illustrating the spreading of cell when the dryness is high;

FIG. 4 is an exemplary sample slide obtained in the case of FIG. 3;

FIG. 5 is a schematic view illustrating the spreading of cell when the dryness is optimal;

FIG. 6 is an exemplary sample slide obtained in the case of FIG. 5;

FIG. 7 is a schematic view illustrating the spreading of cell when the dryness is low;

FIG. 8 is a cross-sectional view showing a first embodiment of the device for preparing a sample slide of the invention;

FIG. 9 is a plan view showing a substantial part of a second embodiment of the device for preparing a sample slide of the invention;

FIG. 10 is a cross-sectional view of the device for preparing a sample slide shown in FIG. 9 cut along line X-X;

FIG. 11 is a cross-sectional view of the device for preparing a sample slide shown in FIG. 9 cut along line XI-XI;

FIG. 12 is a cross-sectional view showing a third embodiment of the device for preparing a sample slide of the invention;

FIG. 13 is a plan view showing a substantial part of the device for preparing a sample slide shown in FIG. 12;

FIG. 14 is a schematic view illustrating a structure of a centrifuge according to the third embodiment of the device for preparing a sample slide of the invention;

FIG. 15 is a schematic view illustrating a structure of an automated dryness controller according to the third embodiment of the device for preparing a sample slide of the invention;

FIG. 16 is a flowchart showing a procedure at a first stage for preparing a glass sample slide with the sample slide preparing device of the third embodiment;

FIG. 17 is a flowchart showing a procedure at a second stage for preparing a glass sample slide with the sample slide preparing device of the third embodiment;

FIG. 18 is a flowchart showing a procedure at a third stage for preparing a glass sample slide with the sample slide preparing device of the third embodiment;

FIG. 19 is a schematic view showing a conventional method for fixing a cell-floating fluid (flame fixing technique);

FIG. 20 is a schematic view showing a conventional method for fixing a cell-floating fluid (steam fixing technique);

FIG. 21 is a schematic view showing a conventional method for fixing a cell-floating fluid (hot plate fixing technique); and

FIG. 22 is a schematic view showing a conventional method for fixing a cell-floating fluid (naturally dried fixing technique).

### BEST MODE FOR CARRYING OUT THE INVENTION

First, a method for preparing a sample slide of the invention will be described.

The method for preparing a sample slide of the invention is characterized in that dryness in an enclosed space for spreading a cell-floating fluid as an analyte is controlled.

In order to control the dryness according to the present embodiment, the dryness needs to be determined. Determination of the dryness herein refers to determination of how much moisture that ambient atmosphere can take up. This can be calculated based on an actual moisture content under that environment and a saturated moisture content.

The dryness can be calculated based on temperature and absolute humidity as follows.
Dryness [Idry]=Saturated moisture content [Ws]−Absolute humidity [AbsH].
Dryness [Idry]: Dryness (g/m³)
Saturated moisture content [Ws]: Saturated moisture content at temperature T° C. (g/m³)
Absolute humidity [AbsH]: Absolute humidity (g/m³)

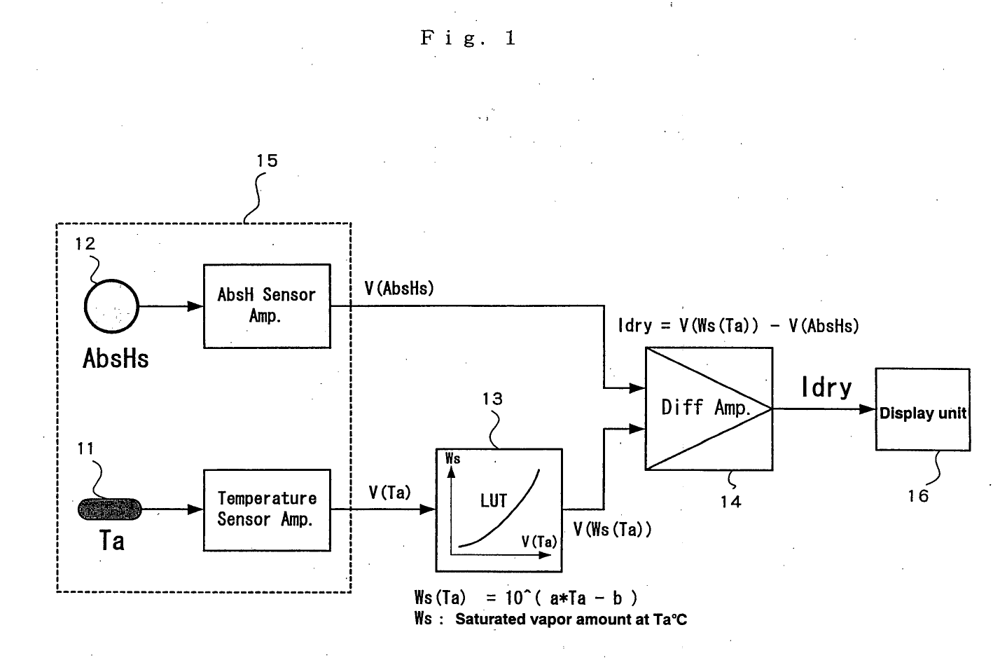

With reference to FIG. 1, according to the present embodiment, a temperature sensor 11 is arranged at a site where the temperature of the surface of the sample slide 1 where a cell-floating fluid is dropped and the ambient temperature in the environment for spreading the cell-floating fluid can properly be measured. A humidity sensor 12 is placed in the spreading environment. A detection circuit (a saturated moisture content detecting unit) 13 outputs a saturated moisture content at a temperature detected by the temperature sensor 11. The output from the detection circuit 13 and the absolute humidity actually measured by the humidity sensor 12 are used such that a control circuit (a dryness calculating unit) 14 outputs dryness according to the above-mentioned equation and the result is displayed on a display unit 16. In FIG. 1, the temperature sensor and the humidity sensor are illustrated as a dryness sensor 15 having both of the functions.

The dryness is based on two factors, i.e., an energy put upon the fluid and how much of the vaporized fluid the ambient atmosphere can take up.

The energy that rises upon preparing the sample slide refers to heat energy. In order to give a constant heat energy, the surface temperature of the glass slide 1a (where the cell-floating fluid 3 is dropped 4) needs to be kept constant. Therefore, the thermostatic property of the surface of the glass slide is an important factor.

The amount of fluid that can be taken up in the atmosphere of the environment is determined according to the vapor pressure of the vaporized fluid. When mixed gases are used, the vapor pressure changes according to the proportion of the gases in the mixture. The cell-floating fluid 3 used for the preparation of the sample slide according to the present embodiment is Carnoy's fixtative, a mixture of acetic acid and methanol. Both liquids evaporate. According to the present embodiment, the dryness is controlled by controlling the amount of vapor in the vaporizing environment to control the vaporized amount of the Carnoy's fixtative.

By controlling the amount of vapor in the environment for spreading the cell-floating fluid 3, an environment with a humidity optimal for preparing a sample slide is produced. By equilibrating vapor pressures of methanol/acetatic acid and water, dryness of the dropped cell-floating fluid is kept optimal. As a result, a sample slide 1 with an optimal cell or chromosome fixing is obtained.

Specifically, while a predetermined amount of the cell-floating fluid 3 is supplied, namely a predetermined amount of an analyte is dropped, and a predetermined concentration of acetic acid in the Carnoy's fixtative is used for fixing the analyte, the saturated moisture value output at this temperature and the actual humidity are used to calculate the dryness according to the above-mentioned equation. The saturated moisture value at the calculated temperature is calculated for various combinations of the supply amount of the cell-floating fluid 3 and the concentration of the acetic acid in the Carnoy's fixtative so that these values are stored in a memory such as ROM (not shown) for the above-mentioned saturated moisture value detecting unit 13 to be able to refer to the memory.

For example, when the amount of the cell-floating fluid 3 supply is fixed to 0.04 ml while the acetic acid concentration in the Carnoy's fluid is fixed to 3:1 (methanol: acetic acid), the dryness at a temperature of 30° C. is 5-10 g/m², preferably 7 g/m². Thus, the vapor amount in the vaporized environment is controlled to give this dryness.

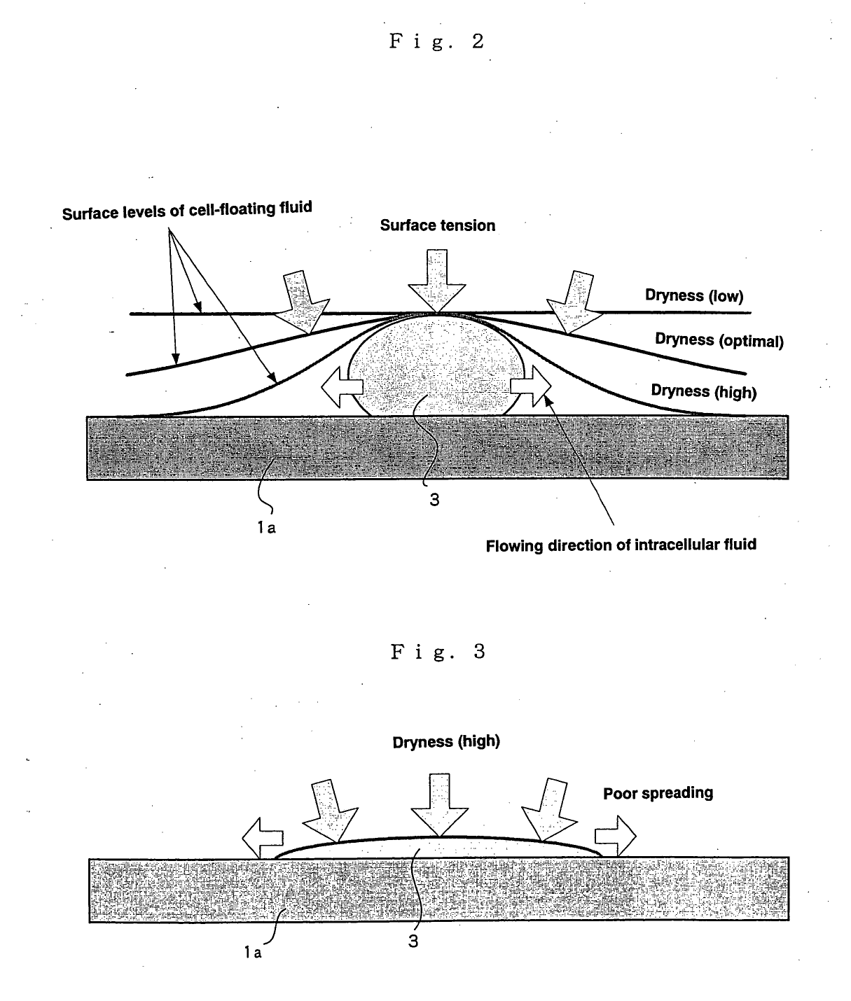

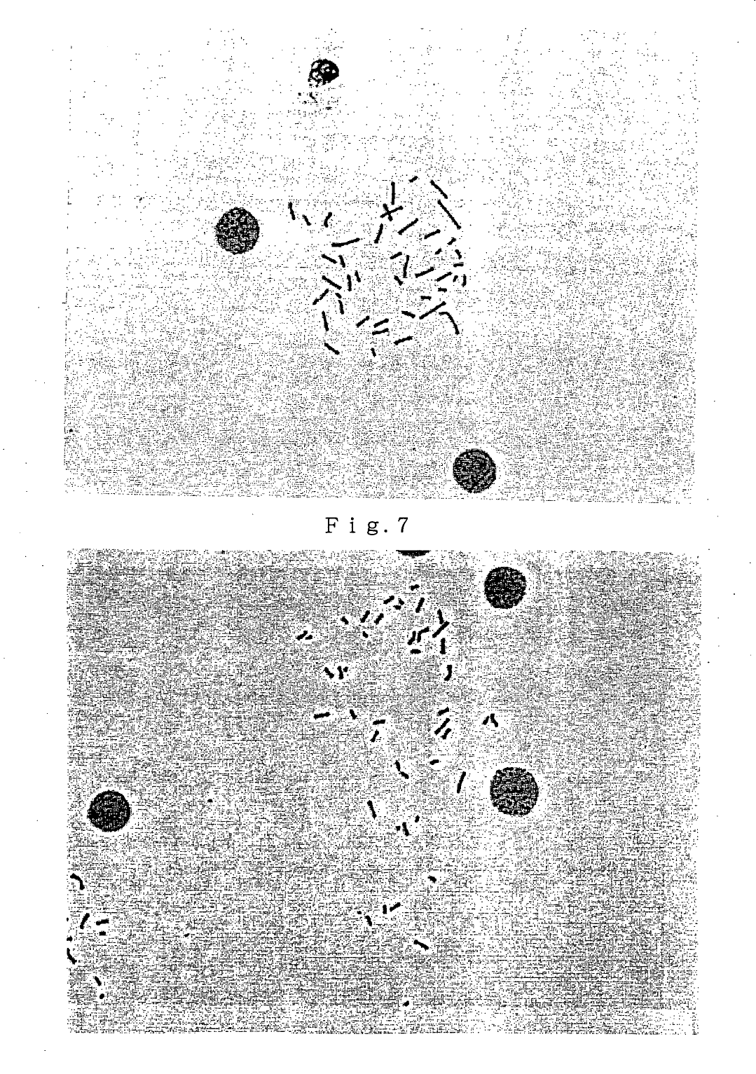

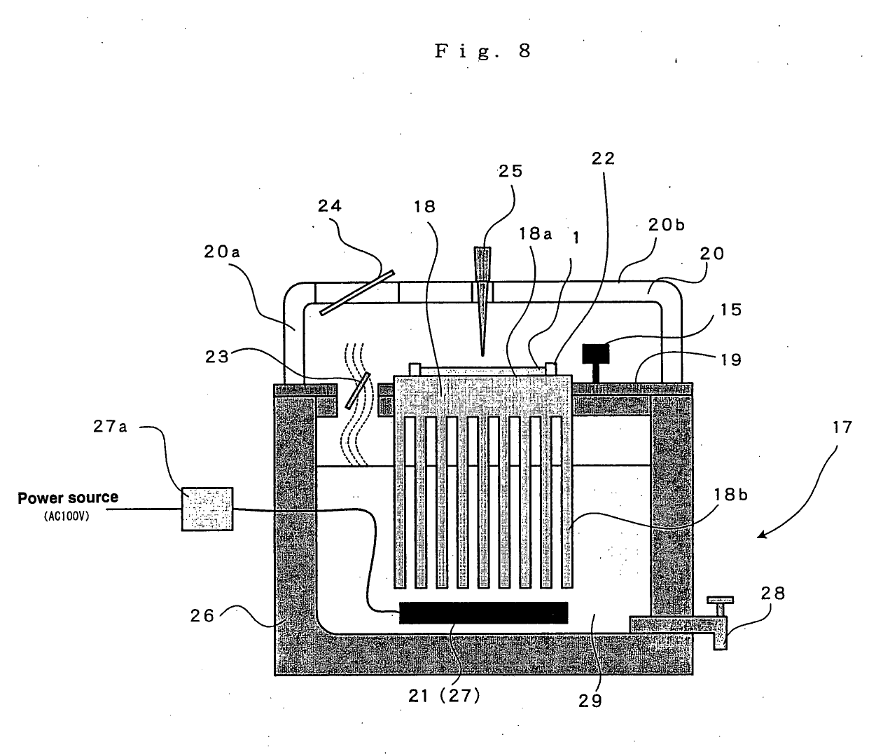

Hereinafter, the relationship between the dryness and the spreading of the cell will be described with reference to FIGS. 2 to 7. The lower the dryness is, the wider the cell-floating 3 spreads. On the contrary, higher dryness keeps the cell-floating fluid 3 to stay smaller.

The cells after being dropped on the slide travels in various direction along with the fluid and adhere on the surface of the glass slide 1a as the Carnoy's fluid evaporates. As the cell adhered on the glass slide 1 spreads, first the cell membrane is broken due to the surface tension of the Carnoy's fluid and the intracellular fluid containing the chromosome and the like begins to flow.

However, at the size level of a cell, Reynolds number (=(inertial force/viscous power)=(density/viscosity)×(length)×(rate)) is very small, and thus the viscosity of the intracellular fluid becomes high in the area so the flow rate is very low.

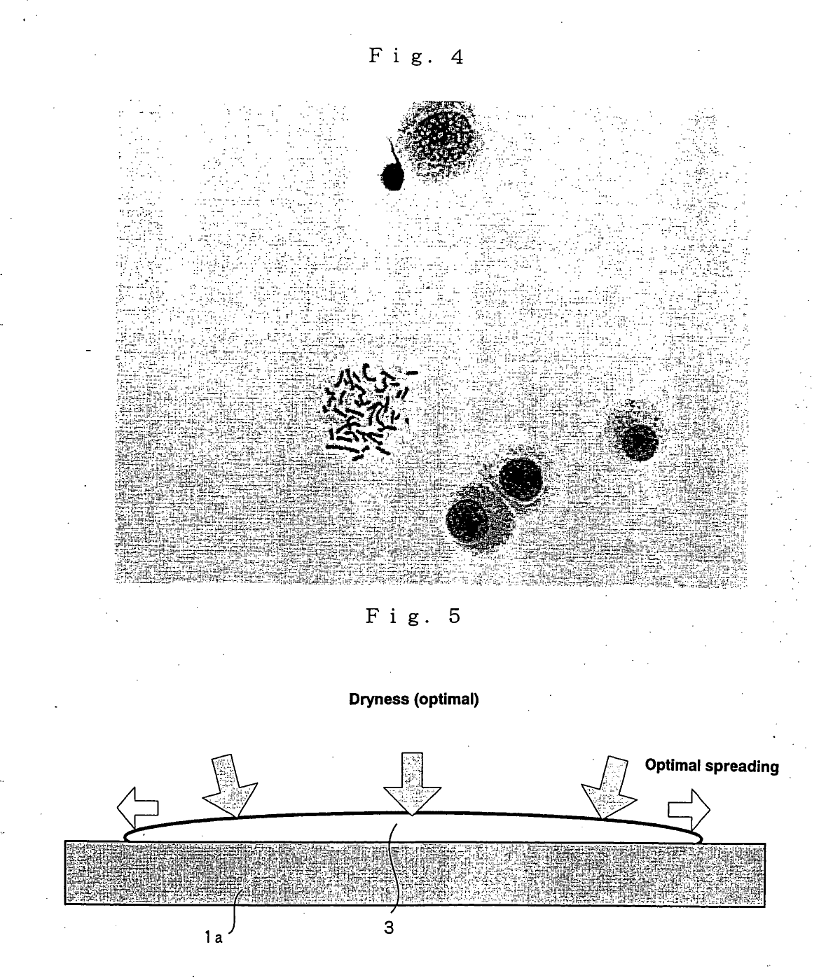

The intracellular fluid is believed to be a fluid with a great viscosity (for example, internal viscosity of a white blood cell is 13 Pa/s). When the flow rate of the intracellular fluid is slower than the descending rate of the surface level of the dropped cell-floating fluid, the cell is fixed with small spreading as shown in FIGS. 3 and 4. When the drying rate is optimal, optimal spreading as shown in FIGS. 5 and 6 can be achieved. When the drying rate is slow (dryness is low), the chromosome as an internal substance of the cell spreads out too much such that it no longer stays at one site but is dispersed, and thus the resulting sample is not suitable for genome analysis or the like.

According to the method for preparing the sample slide of the present embodiment, among the control parameters involved in optimal fixing of the cell or chromosome onto a sample slide, dryness of the cell-floating fluid 3 dropped 4 is particularly controlled. As a result, anyone can prepare a sample slide with an optimal cell or chromosome fixing as shown in FIGS. 5 and 6.

Next, the above-described method for preparing a sample slide will be described more specifically.

First, the cell-floating fluid 3 as an analyte is cultured beforehand followed by hypotonic treatment and Carnoy's fixative treatment. As described above, the cell-floating fluid 3 used for preparing a sample slide of the present embodiment is a Carnoy's fixative which is a mixture solution of acetic acid and methanol.

On the other hand, a temperature sensor 11 and a humidity sensor 12 placed in the environment for spreading the Carnoy's fixative, or the cell-floating fluid 3 are used to measure the temperature and the humidity in the spreading environment. A saturated moisture value detecting unit 13 outputs a saturated moisture at that temperature based on the amount of cell-floating fluid 3 supply, i.e., the amount of analyte dropped, and the concentration of the acetic acid in the Carnoy's fixative added upon preparing the analyte. Then, a dryness calculating unit 14 calculates the dryness according to the above-mentioned equation using the output of the saturated moisture value and the actual absolute humidity. A display unit 16 constantly outputs this dryness.

This output dryness in the spreading environment is adjusted to a value optimal for fixing the analyte. Specifically, the spreading environment is exposed to outside to release the humidity from the environment to lower the humidity inside the spreading environment. Alternatively, the spreading environment is humidified, or in some cases heated or cooled to alter the saturated moisture value at that temperature to attain the most optimal dryness.

In this adjusted environment, a predetermined amount of the cell-floating fluid 3 is dropped 4 on the surface of the sample slide 1 placed in an enclosed space as the spreading environment and left for a predetermined period of time. The dry atmosphere inside the enclosed space allows optimal spreading and fixing of the analyte. Next, a device for carrying out the method for preparing a sample slide will be described specifically.

FIG. 8 is a cross-sectional view showing a substantial fundamental structure of a first embodiment of the device for preparing a sample slide of the invention.

The main body of the device 17 for preparing a sample slide of the present embodiment is provided with a thermostatic block 18 on which a glass slide 1a is mounted and which provides a stable amount of heat to the glass slide 1a, a face place 19 for supporting the thermostatic block 18, a spreading space cover 20 for forming an enclosed space above the face plate 19 as an environment for spreading a metaphase analyte on the glass slide 1a, and a heating unit 21 for appropriately controlling the temperature of the cell-floating fluid 3 as an analyte via the thermostatic block 18 supported by the face place 19.

According to the present embodiment, the thermostatic block 18 is provided with a rectangular thermostatic block member 18a and a heat transferring member 18b having a plurality of plate fins aligned in parallel and generally vertical to and integral with the bottom surface of the thermostatic block member 18a. In the present embodiment, the entire thermostatic block 18 is made of a metal with good heat conductivity, i.e., aluminum, in a size sufficient to provide a satisfactory heat capacity. The thermostatic block member 18a is supported by the face place 19 such that the upper surface thereof is generally horizontally exposed. One or more slide guides 22 are provided on the upper surface of the thermostatic block member 18a. The slide guides 22 guide one or more glass slides 1a to be mounted.

The face plate 19 is provided with a first humidity adjusting fin 23 which allows communication between inside and outside a storage tank described later. A dryness sensor 15 is provided on the face plate 19 in the vicinity of the thermal block member 18a, which sensor 15 calculates dryness inside the enclosed space for spreading a metaphase analyte on the glass slide 1a. The dryness sensor 15 includes sensors that can measure the temperature and the humidity in the enclosed space, which are data necessary for calculating the dryness.

The spreading space cover 20 includes surrounding walls (side panels) 20a and a ceiling (top panel) 20b which, together with the face plate 19 (bottom panel) supporting the thermostatic block 18, form the enclosed space. The ceiling 20b of the spreading space cover 20 is provided with a second humidity adjusting fin 24 that allows communication between inside and outside the sample slide preparing device, at a part opposing the first humidity adjusting fin 23 in an enclosed state of the cover 20. The ceiling 20b is further provided with a pipette 25 with its tip being arranged such that the cell-floating fluid 3 as an analyte can be dropped 4 on the center part of the glass slide 1a mounted on the thermostatic block 18.

The heating member 21 is arranged below the face plate 19 and forms a homeothermal water bath with a storage tank 26 in which the thermostatic block 18 is partially immersed and a heater 27 for heating the water stored in the tank 26 to an appropriate temperature. The surrounding walls 26a and the bottom 26b of the storage tank 26 are made of a heat insulating material. At the bottom of the surrounding wall 26a of the storage tank 26, a discharge cock 28 is provided for discharging the stored water. According to the present embodiment, the heater 27 can manually be switched on or off. Alternatively, a dryness controlling unit 30 described later may automatically control the switching and timing of an electric current to control heating. The face plate 19 is arranged to cover the entire upper opening of the storage tank 26. The lower ends of the plate fins of the heat transferring member 18b are immersed in water 29 at an appropriate temperature stored in the storage tank 26.

The device 17 for preparing the sample slide of the present embodiment, is further provided with peripheral equipments such as a pump controlling unit (not shown), the saturated moisture value detecting unit 13, the dryness calculating unit 14, a MANUAL/AUTOMATIC control switch (not shown) and a dryness controlling unit (not shown) that takes over controls when the control switch is switched to AUTOMATIC.

The supply pump (not shown) of the pump controlling unit supplies a predetermined amount of a cell-floating fluid 3 that has been cultured and subjected to hypotonic treatment, dropwise to the surface of the sample slide 1 via a carrier pipe (not shown) and the drop pipette 25 arranged in the enclosed space.

The saturated moisture value detecting unit 13 detects the saturated moisture value at the temperature measured by the temperature sensor 11 by referring to the memory. The dryness calculating unit 14 outputs and displays on the display unit 16 the dryness in the spreading environment calculated according to the above-mentioned equation based on the saturated moisture value and the value obtained by the humidity sensor 12. Moreover, when AUTOMATIC is selected by the MANUAL/AUTOMATIC control switch, the dryness controlling unit is initiated.

The dryness controlling unit refers to the resulting dryness calculated by the dryness calculating unit 14, controls switching of the heater 27 of the homeothermal water bath and the timer 27a and, when it is provided with a mechanism for automatically opening and closing the first humidity adjusting fin 23 and the second humidity adjusting fin 24, controls the opening and the closing thereof so that optimal dryness is obtained in the analyte spreading environment.

Hereinafter, a method for preparing a sample slide using the sample slide preparing device of the present embodiment will be described briefly.

First, a glass slide 1a is placed on the upper surface of the heated thermostatic block member 18a as guided by the slide guide 22. Then, the spreading space cover 20 is closed to enclose the environment for spreading a metaphase analyte. At this point, a predetermined amount of a cell-floating fluid 3 is dropped 4 on the glass slide 1a by the supply pump of the pump controlling unit via the drop pipette 25 to spread a metaphase analyte.

In the enclosed space as the spreading environment, the water stored in the storage tank 26 is heated to an appropriate temperature 29 by running a current to the heater 27 arranged in the storage tank 26. The surface of the thermostatic block member 18a is heated to an appropriate temperature via the plate fins of the heat transferring member 18b where the lower ends of the plate fins are immersed in the water at the appropriate temperature 29. According to the present embodiment, the dryness calculated by the saturated moisture value detecting unit 13 and the dryness calculating unit 14 and displayed on the display unit 16 is adjusted to a humidity optimal for spreading the analyte within the enclosed environment. Specifically, the opening or closing of the first humidity adjusting fin 23 is controlled to send excess vapor from the water at the appropriate temperature 29 filling the storage tank 26 to the spreading environment to keep the predetermined dryness that is constantly under control. Alternatively, the opening or closing of the second humidity adjusting fin 24 is controlled to expose the sample slide preparing device 1 to outside with lower humidity to obtain desirable dryness. If necessary, the heater 27 is switched on to adjust the temperature of the water 29 for vapor production or humidification. When AUTOMATIC is selected by the MANUAL/AUTOMATIC control switch, the opening or closing of the first and second humidity adjusting fins 23 and 24 is automatically controlled via the dryness controlling unit 30 as described above.

Thus, the analyte on the sample slide 1 is dried by being exposed to the adjusted dry atmosphere in the spreading environment.

By controlling the dryness as the parameter involved in preparing the sample slide 1, the metaphase analyte can be formed into an appropriate shape and anyone can prepare an appropriate sample slide 1 with stable quality.

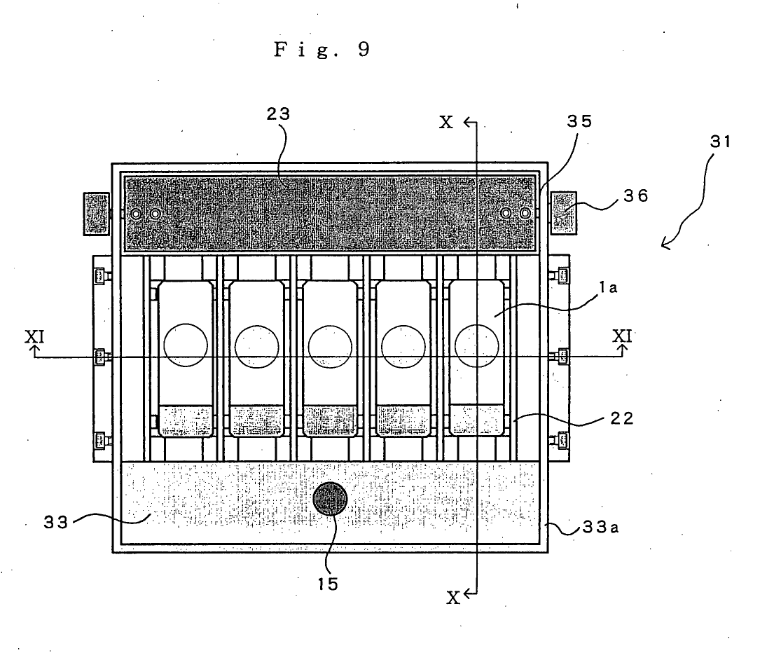

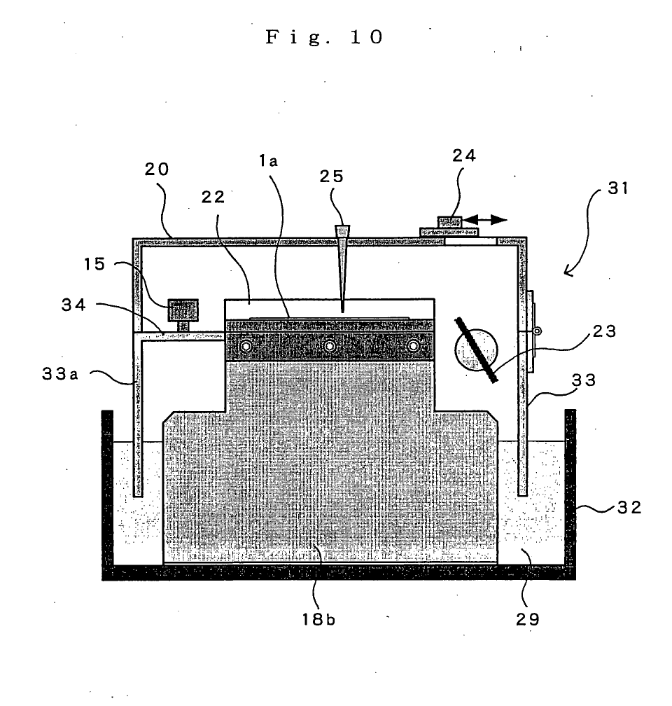

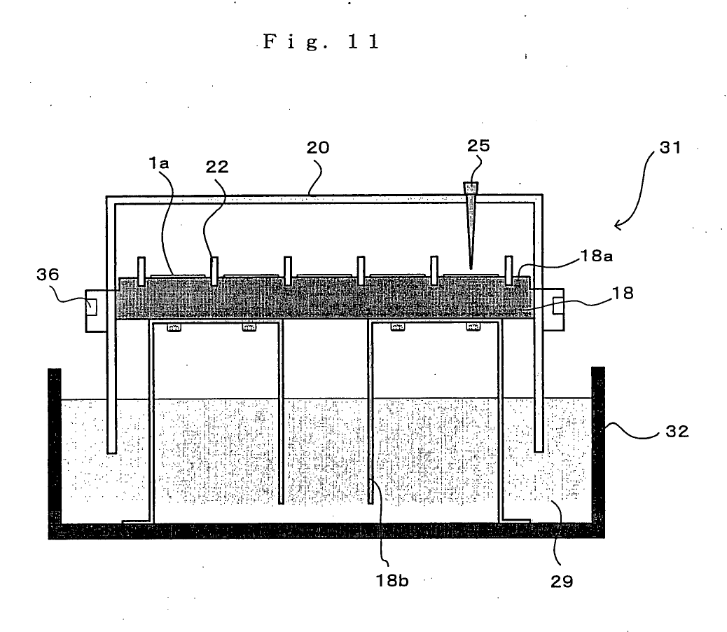

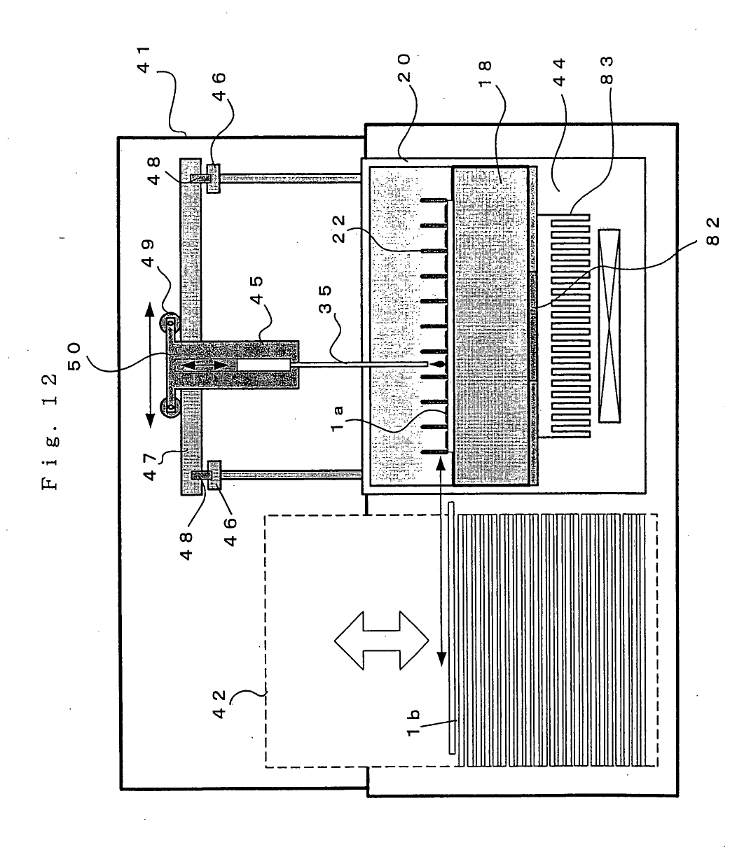

FIGS. 9 to 11 are schematic views showing fundamental structure of a second embodiment of a device for preparing a sample slide of the invention.

The sample slide preparing device 31 of the present embodiment is particularly distinct from the device of the first embodiment in that a commercially-available water bath 32 is used instead of the storage tank 26 as the homeothermal water bath for controlling the temperature of the thermostatic block 18. Hereinafter, parts of the structure that differ from those of the sample slide preparing device 17 described above will be described briefly. Parts that are identical to those of the sample slide preparing device 17 of the first embodiment will be denoted by the same reference numbers and the descriptions thereof are omitted.

The sample slide preparing device 31 according to the present embodiment is provided with a spreading device 33 for spreading an analyte on a glass slide 1a and the water bath 32 mentioned above.

The spreading device 33 includes a rectangular chassis 33a that covers a thermostatic block 18 in a strip-like arrangement at the upper center part between a pair of side walls of the chassis 33a, a top board 34 integrally formed with the side wall of the chassis 33a so as to fill the gap between the thermostatic block 18 and the chassis 33a at one side of the thermostatic block 18, and a first humidity adjusting fin 23 made of a single board supported at an axis by a rotation shaft 35 between the thermostatic block 18 and the chassis 33a at the other side of the thermostatic block 18.

The chassis 33a is hinged to a spreading space cover 20 that can freely be opened and closed to provide an enclosed space for spreading an analyte above the thermostatic block 18, the top board 34 and the first humidity adjusting fin 23.

A plurality of glass slides 1a can be aligned on the upper surface of the thermostatic block 18 with slide guides 22 arranged therebetween as separators for preventing the cell-floating fluid 3 dropped on the glass slide 1a from invading the adjacent glass slide 1a.

To the bottom surface of the thermostatic block 18, a heat transferring member 18b is secured which stands in the water bath 32 as feet of the spreading device 33 and functions as heat transfer fins for providing stable heat to the glass slides 1a from the water 29 at an appropriate temperature stored in the water bath 32 via the thermostatic block 18.

The top board 34 is provided with a dryness sensor 15 identical to that of the first embodiment. Both ends of the rotation shaft 35 supporting the first humidity adjusting fin 23 stick out of the opposing side walls of the chassis 33a and are provided with adjustment knobs 36. The adjustment knobs 36 can be grabbed and rotated so that the first humidity adjusting fin 32 ( [symbol] 23?) can be rotated manually.

A second humidity adjusting fin 24 for communicating inside and outside the sample slide preparing device 31 is slidably arranged at a part of the ceiling 20b of the spreading space cover 20 so as to oppose the first humidity adjusting fin 23 when the spreading space cover 20 is in a closed state. The ceiling 20b is also provided with a drop pipette 25 such that a cell-floating fluid 3 as an analyte can be dropped 4 on the center of each glass slide 1a aligned on the surface of the thermostatic block 18.

The water bath 32 is filled with water 29 at an appropriate temperature which is kept at a constant temperature with a heater for adjusting the temperature (not shown).

The lower end of the heat transferring member 18b, or the heat transfer fins and the entire lower circumference of the chassis 33a of the spreading device 33 are placed in the water at the appropriate temperature in the water bath 32.

Similar to the first embodiment, such sample slide preparing device 31 is able to prepare a sample slide 1 with a desirable spreading of the analyte. Since the sample slide preparing device 31 of the present embodiment utilizes a commercially available water bath 32, the cost thereof can be lowered. In addition, the device can be downsized even with a plurality of glass slides 1a in an alignment arrangement.

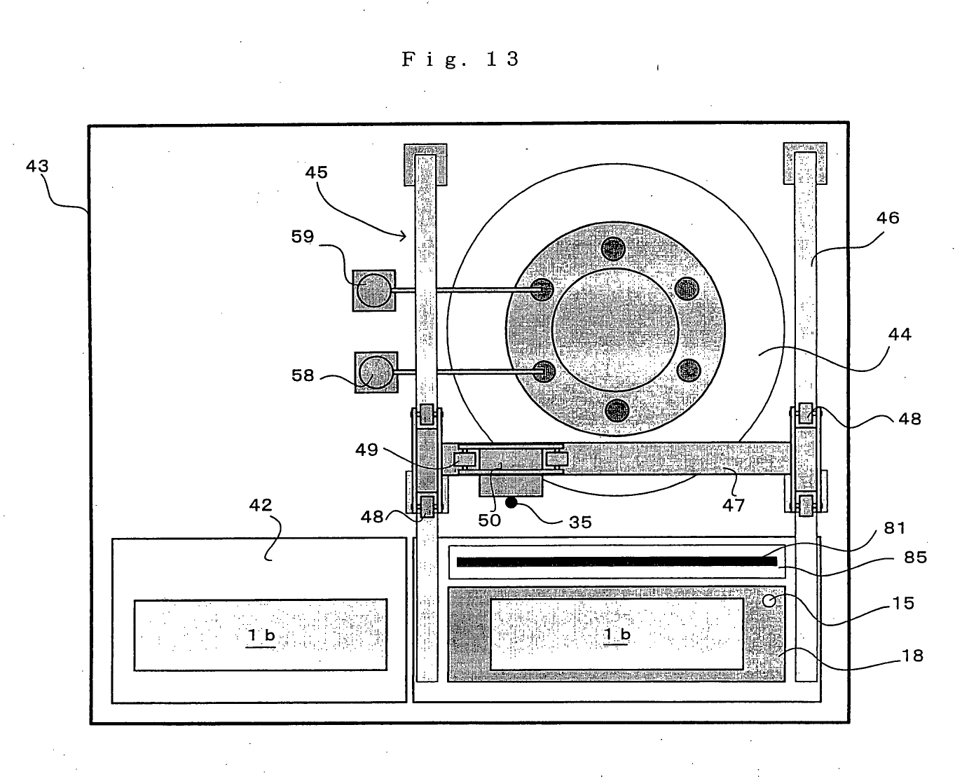

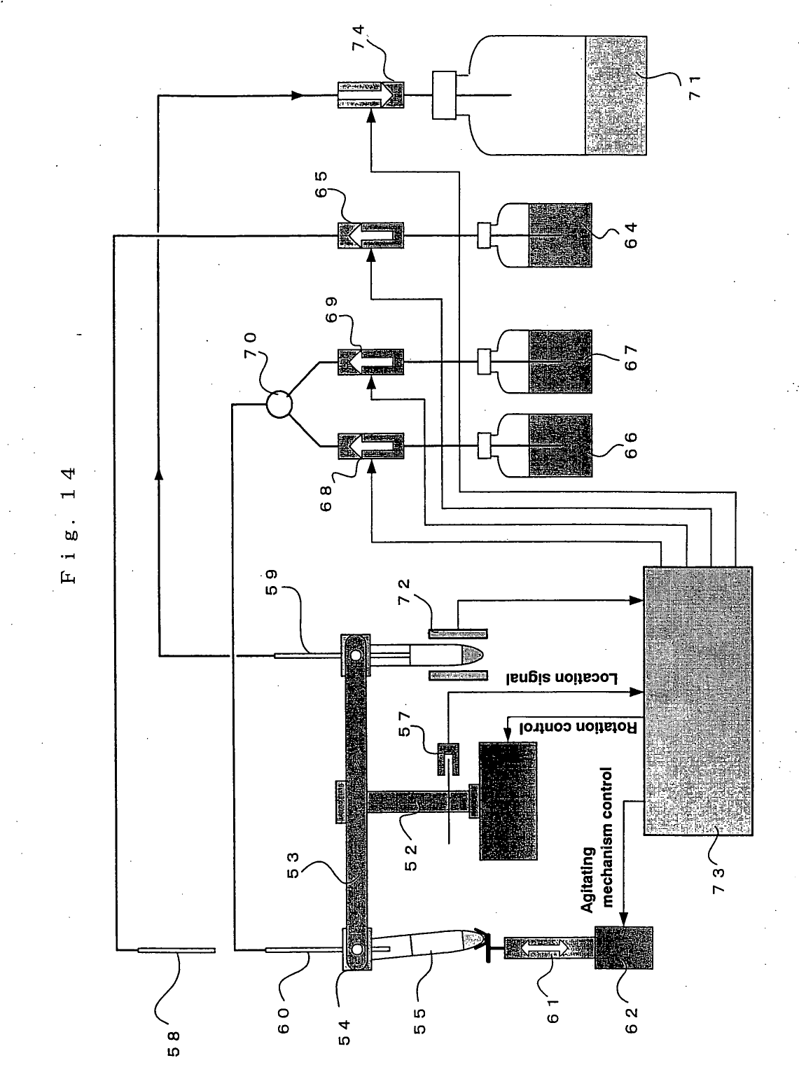

A sample slide preparing device 40 shown in FIGS. 12 and 13 performs cell harvest by repeating hypotonic treatment and Carnoy's fixation treatment using a centrifuge 44, and automatically prepares a sample slide of a cell or a chromosome in a spreading environment adjusted to dryness of optimal fixing conditions as described above. Parts identical to those of the sample slide preparing device 17 of the first embodiment will be denoted by identical reference numbers and the descriptions thereof are omitted.

The sample slide preparing device 40 according to the present embodiment is provided with a thermostatic block 18 for fixing an analyte at one side within a rectangular main body 41. A slide cassette 1b including a set of glass slides 1a is supplied on the upper surface of the thermostatic block 18 from the adjacent glass slide supplying cassette unit 42. A liquid analyte preparing mechanism 43 for obtaining a liquid analyte to be dropped on a sample slide 1 is arranged at the back of the thermostatic block 18. The liquid analyte preparing mechanism 43 mainly consists of a centrifuge 44 and a XYZ-direction movable pipetting mechanism 45 for dropping the liquid analyte on the sample slide 1.

Two parallel elevated rails 46 longitudinally run along both sides of the thermostatic block 18 and the centrifuge 44. The XYZ-direction movable pipetting mechanism 45 can run along the elevated rails 46 via rollers 48 and includes a pipette supporting unit 50 which can run along a crossing rail 47 bridging between the elevated rails 46 via rollers 49. The pipette supporting unit 50 is provided with a drop pipette 25 that is free to move up and down.

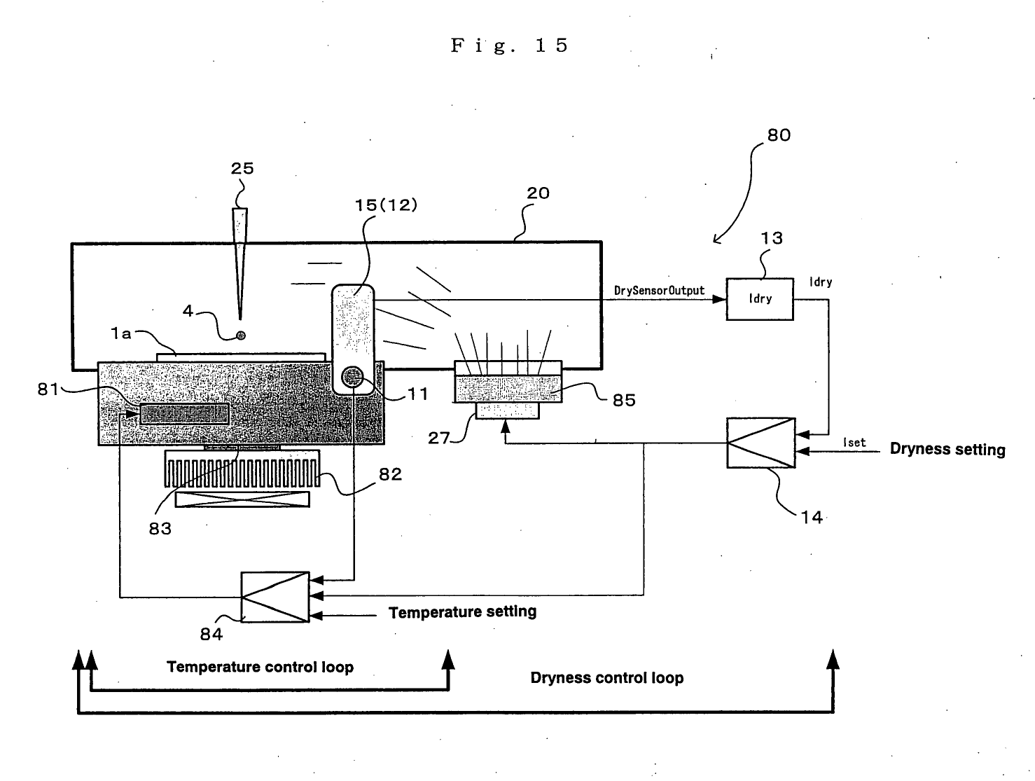

The centrifuge 44 will be described with reference to FIG. 14.

The centrifuge 44 includes a rotation member 53 secured to an open end of a rotation axis 52 of a centrifuge rotating mechanism 51 such as a motor. Six oscillating buckets 54 are arranged evenly spaced apart along the outer circumference of the rotation member 53 having the rotation axis 52 at the center. Each of the oscillating buckets 54 is provided with a tube 55 rotatable around the center axis thereof. The centrifuge position detecting mechanism 56 detects that each of the tubes 55 has halted at a predetermined halt position. Specifically, halt position marks (not shown) provided along an outer circumference of a sensor disk 57a secured to the rotation axis 52 are detected with a sensor 57.

As shown in FIG. 14, a hypotonic solution pipette 58 for injecting a predetermined amount of liquid reagent (hypotonic solution or Carnoy's fixative) into the tubes 55 held by the oscillating buckets 54 and a discharge pipette 59 for discharging a predetermined amount of liquid from the tubes 55 are provided around the centrifuge 44. As shown in FIG. 14, a Carnoy's fixative pipette 60 is also provided at the same position as the hypotonic solution pipette 58. An agitating mechanism 63 is arranged below the hypotonic solution pipette 58, which mechanism 63 has a driving member (not shown) including an up-and-down agitating mechanism 62 that holds the lower end of each of the halting tubes 55 with an upwardly extending gripper 61 to move each tube 55 up and down to allow axial rotation of each tube 55 in clockwise and anti-clockwise directions with respect to the oscillating buckets 54. The hypotonic solution pipette 58 is supplied with a hypotonic solution from a hypotonic reagent bottle 64 with a delivery pump 65. The Carnoy's fixative pipette 60 is supplied with acetic acid from an acetic acid bottle 66 and methanol from a methanol bottle 67 at a predetermined proportion (1:3 in the present embodiment) with delivery pumps 68 and 69, respectively, via a mixer 70 where the two substances are mixed. The drainage in the tubes 55 is suctioned with the discharge pipette 59 by the discharge pump 74 and discharged into a drainage tank 71. The amount of drainage in the tubes 55 can be detected with a drainage level detector 72.

The centrifuge rotating mechanism 51, the centrifuge position detecting mechanism 56, the agitating mechanism 63 and the delivery pumps 65, 68 and 69 are each connected to and controlled by a controller 73 of the sample slide preparing device 40.

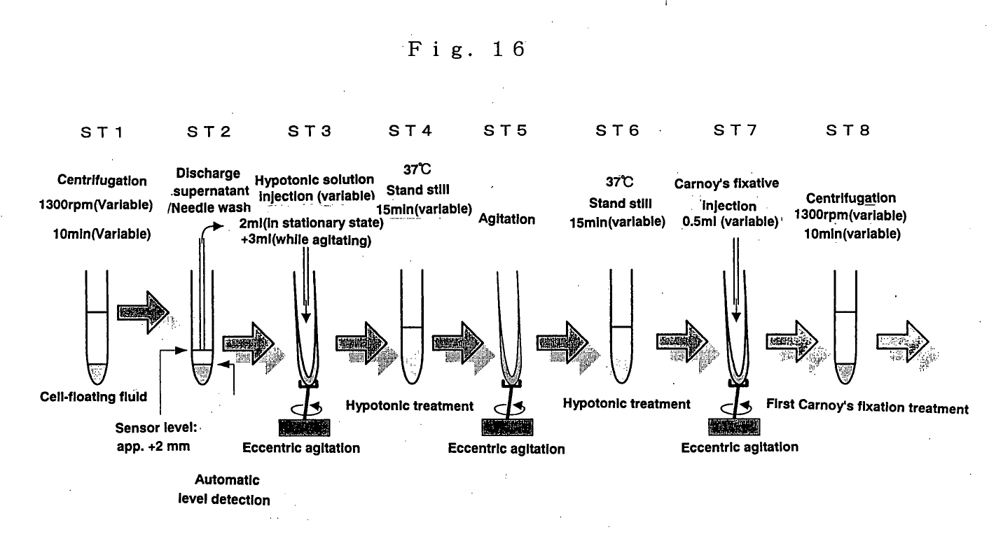

The sample slide preparing device 40 of the present embodiment is also provided with an automatic dryness controller 80 including the above-described dryness calculating unit 14 and the dryness controlling unit 30 as schematically shown in FIG. 15.

As shown in the figure, the automatic controller 80 of the present embodiment includes a temperature control loop and a dryness control loop for the thermostatic block 18 for mounting a glass slide 1a. The temperature control loop includes a temperature sensor 11 arranged in the vicinity of the thremostatic block 18, a temperature adjusting mechanism 83 having a heater 81 and a Peltier cooling element 82 and a temperature control calculating circuit (temperature control calculating unit) 84. The dryness control loop includes the temperature control loop as well as a humidifying water tank 85, a heater 27, a humidity sensor 12, the dryness calculating unit 14 having a saturated moisture value detecting unit for determining a saturated moisture value and the dryness controlling unit 30 for controlling a power supply to the heaters 81 and 27 and the temperature adjusting mechanism 83.

Since the automatic dryness adjusting device 80 of the sample slide preparing device 40 of the present embodiment allows adjustment of the temperature and the dryness in the environment for spreading an analyte, sample preparation conditions suitable for various nucleated cells differing in viscosities of their intracellular fluids can be provided.

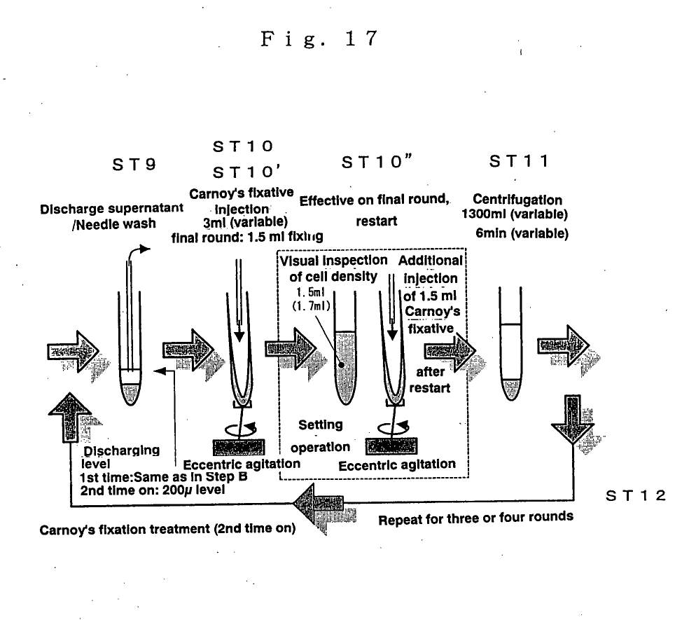

Hereinafter, operations of the present embodiment will be described with reference to FIGS. 16 to 18. The environment for spreading an analyte in the sample slide preparing device of the present embodiment is adjusted according to the above-described method and thus the descriptions thereof are omitted.

FIGS. 16, 17 and 18 are flowcharts illustrating processes at first, second and third stages, respectively, for preparing a sample glass slide with the sample slide preparing device of the present invention.

First, at the preparatory stage, cultured cell-floating fluids are transferred into the six tubes 55 each held with the oscillating buckets 54 of the centrifuge 44.

Then, the centrifuge 44 is driven at 1,300 rpm for 10 minutes. With the above-described centrifuge position detecting device 56, one of the tubes 55 (hereinafter, operations will mainly be described for this single tube 55) is halted at a position of the discharge pipette 59 (Step ST1).

The discharge pipette 59 is inserted into the halting tube 55 from above without touching the inner wall of the tube 55 to a predetermined depth of the supernatant as detected with the drainage level detector 72. Subsequently, the discharge pump 74 is driven to suction the supernatant (about 5 ml) from the tube 55 and to discharge into the drainage tank 71 (Step ST2).

Once the extraction of the supernatant is completed, the discharge pipette 59 is drawn out of the tube 55. Then, the centrifuge rotating mechanism 51 is driven to transfer the tube 55 to the position of the hypotonic solution pipette 58 where a predetermined amount (5 ml) of a hypotonic solution is injected into the tube 55 from the hypotonic solution pipette 58 by driving the delivery pump 65. Thereafter, the tube 55 is subjected to eccentric agitation in a pestle-like movement (Step ST3).

The tubes 55 are sequentially transferred at one halt position at a time in a rotation direction of the rotating member 53 to repeat the processes of Steps ST2 and ST3.

Then, the rotating member 53 is stopped for about 15 minutes while the temperature is kept at 37° C. for hypotonic treatment (Step ST4).

Thereafter, all of the tubes 55 are sequentially subjected to second agitation at the position of the hypotonic solution pipette 58 (Step ST5).

The tubes 55 after the second agitation are subjected to hypotonic treatment as in Step ST4 (Step ST6).

At a position of the hypotonic solution pipette 58, a predetermined amount (0.5 ml) of Carnoy's fixative is injected for the first time from the Carnoy's fixative pipette 60 by driving the delivery pumps 66 and 67. Thereafter, the tube 55 is subjected to eccentric agitation in a pestle-like movement (Step ST7).

The tubes 55 are sequentially transferred at one halt position at a time; in a rotation direction of the rotating member 53 to repeat the process of Step ST7.

Then, the centrifuge 44 is driven at 1,300 rpm for 10 minutes (Step ST8).

Next, as shown in FIG. 17, when the centrifuge 44 is stopped, the discharge pipette 59 is inserted into the halting tube 55 from above without touching the inner wall of the tube 55 to a predetermined depth of the supernatant as detected with the drainage level detector 72. Subsequently, the discharge pump 74 is driven to suction the supernatant from the tube 55 and to discharge into the drainage tank 71 (Step ST9).

Once the extraction of the supernatant is completed, the discharge pipette 59 is drawn out of the tube 55. Then, the centrifuge rotating mechanism 51 is driven to transfer the tube 55 to the position of the hypotonic solution pipette 58 so as to inject a predetermined amount (3 ml) of the Carnoy's fixative for the second time into the tube 55 from the Carnoy's fixative pipette 60 by driving the delivery pumps 66 and 67 as in Step ST7. Thereafter, the tube 55 is subjected to eccentric agitation in a pestle-like movement (Step ST10).

The tubes 55 are sequentially transferred at one halt position at a time in a rotation direction of the rotating member 53 to repeat the processes of Steps ST9 and ST10.

When all of the tubes 55 have completed agitation, the centrifuge 44 is driven at 1,300 rpm for 6 minutes (Step ST11).

Once the centrifuge 44 is stopped, each of the tubes 55 halted at the position of the discharge pipette 59 is sequentially subjected to the processes of Steps ST9 to ST11 for three to four times (Step ST12). At the final round, the amount of Carnoy's fixative injected at Step ST10 is made 1.5 ml, and the tube 55 is subjected to eccentric agitation in a pestle-like movement (Step ST10′). Thereafter, the procedure is paused for visual inspection after which 1.5 ml of Carnoy's fixative is injected again followed by eccentric agitation as described for Step ST10 (Step ST10″). Next, the operation proceeds to Step ST11.

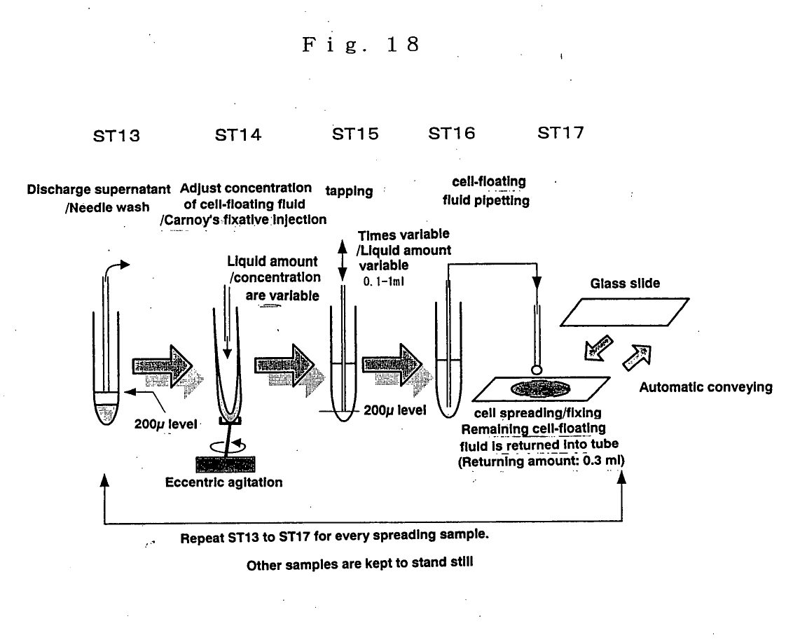

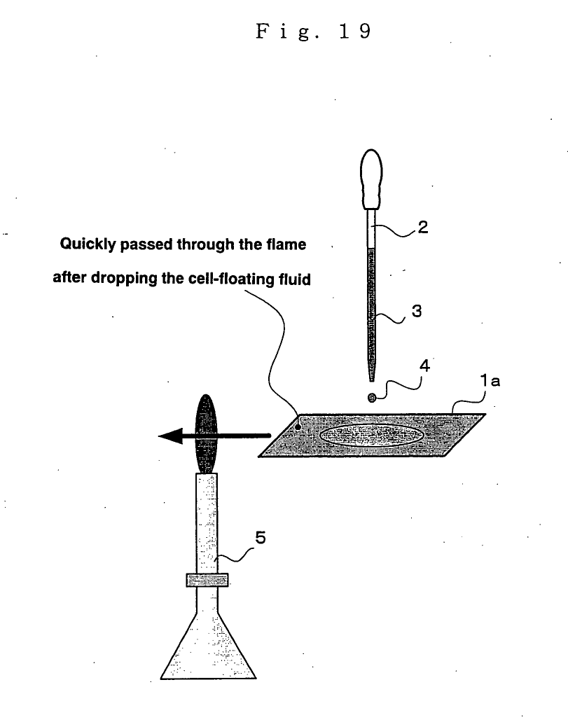

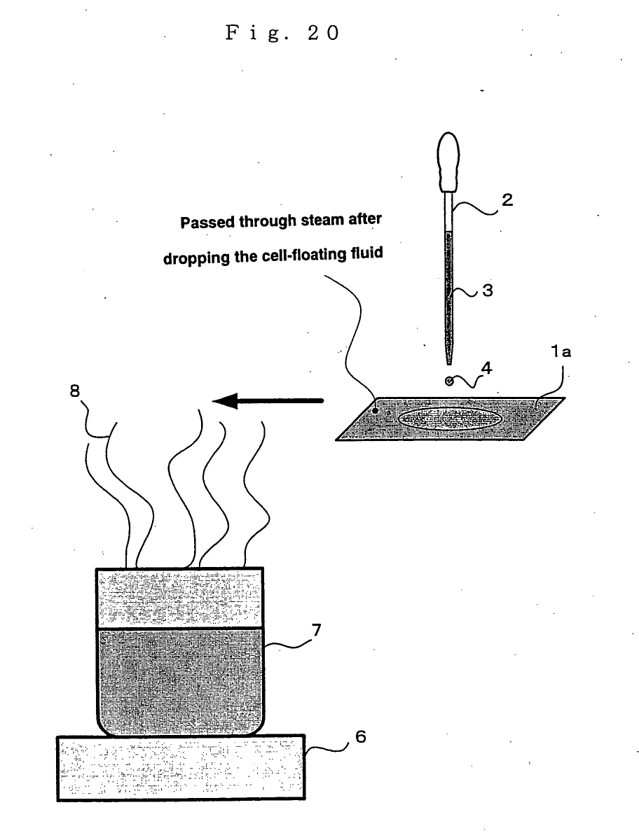

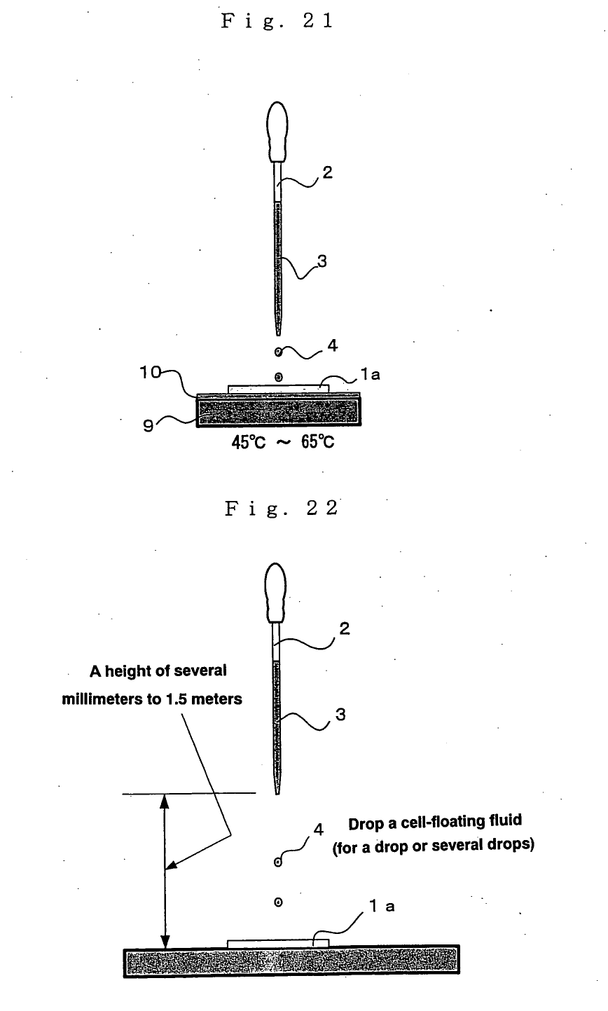

After the final centrifugation, the operation proceeds to FIG. 18.

At Step ST13 in FIG. 18, supernatant in each of the tubes 55 sequentially halting at the position of discharge pipette 59 is suctioned as in Steps ST9 and ST10.

Then, Carnoy's fixative for adjusting the cell-floating fluid is injected for the last time into the tube 55 halting at the position of hypotonic pipette 58 from the Carnoy's fixative pipette 60 by driving the delivery pumps 66 and 67. Thereafter, the tube 55 is subjected to eccentric agitation in a pestle-like movement (Step ST14). Then, the drop pipette 25 is inserted in the tube 55 by driving the XYZ-direction movable pipetting mechanism 45 so as to repeat suctioning and discharging of 0.1 to 1 ml of the cell-floating fluid 3 in the tube 55 as a tapping process (Step ST15).

The supply pump 33 is drivin to collect the cell-floating fluid 3 into the drop pipette 25 (Step ST16). Then, the XYZ-direction movable pipetting mechanism 45 is driven to draw out the drop pipette 25 of the tube 55. Subsequently, the XYZ-direction movable pipetting mechanism 45 is driven to transfer the drop pipette 25 above the spot position of the sample slide 1 and again driven to transfer the tip of the drop pipette 25 immediately above the sample slide 1. The supply pump 33 is driven to drop necessary drops of the cell-floating fluid 3 from the drop pipette 25 to the glass slide 19 (Step ST17).

For each of the spreading sample, the procedure from Step ST13 to Stl7 are repeated for every tubes 55. Until all of the cell spreadings on the glass slides 1a from a single tube 55 are fixed, other samples are kept to stand still.

Thereafter, according to the method described for the embodiment referring to FIG. 1, the cell-floating fluid 3 in a liquid form on the sample slide 1 is well dried with the thermostatic block 18 arranged in the above-described sample slide preparing device, thereby preparing a metaphase with an appropriate shape.

According to the present embodiment, an accurate dropping amount of a liquid analyte, a cell-floating fluid 3 can be dropped on a sample slide 1 with a use of an accurate supply pump while keeping the acetic acid concentration of the Carnoy's fixative constant. Thus, these two parameters can be fixed to constant values.

The present invention is not limited to the above-described embodiments and various modification can be made according to necessity.

1. A method for preparing a sample slide, comprising: a cell-floating fluid is fixed in a spreading environment where dryness, a control parameter of sample slide preparation, is adjusted so as to obtain optimal conditions for preparing the sample slide.

2. The method for preparing a sample slide according to claim 1, wherein the dryness is obtained by providing a temperature and humidity sensors in the spreading environment for the cell-floating fluid to measure the temperature and the humidity within the spreading environment, obtaining a saturated moisture value at the said temperature and, based on this saturated moisture value and the actual absolute humidity, calculating according to the following equation:
Dryness (Idry)=Saturated moisture (Ws)−Absolute humidity (AbsH).

3. A device for preparing a sample slide, comprising: an analyte of a cell or a chromosome is fixed thereon is provided with a mechanism for controlling the dryness of the environment for spreading the metaphase analyte on the sample slide.

4. The device preparing a sample slide according to claim 3, wherein the mechanism for controlling the dryness measures the temperature and the humidity in the cell-floating fluid spreading environment with the temperature and humidity sensors arranged in the environment, obtain the saturated moisture value at the said temperature and, calculate the dryness based on this saturated moisture value and the actual absolute humidity.

5. The device for preparing a sample slide according to claim 3 or 4, further provided with a mechanism for preparing a liquid analyte for obtaining a liquid analyte to be added onto the sample slide dropwise.

6. A device for preparing a sample slide comprising:
a thermostatic block including a thermostatic block member for receiving a glass slide thereon for spreading a methaphase analyte and providing a stable heat and a heat transferring member provided on the bottom surface of the thermostatic block member;
a heating unit including a storage tank for storing water for immersing a part of the heat transferring member and a heater for heating the water stored in the storage tank to an appropriate temperature;
a face plate arranged to cover the entire opening of the storage tank, to support the thermostatic block member such that the upper surface thereof is exposed generally horizontally, provided with a temperature sensor and a humidity sensor in the vicinity of the thermostatic block member for measuring dryness in an enclosed space for spreading the metaphase analyte and provided with a first humidity adjusting fin that allows communication between the spaces separated by said face place;
a second humidity adjusting fin for allowing communication between inside and outside the sample slide preparing device provided with surrounding walls and ceiling that form the enclosed space with the face plate as the bottom plate; and
a spreading space cover provided with a drop pipette for dropping a cell-floating fluid as an analyte on the glass slide mounted on the thermostatic block.

7. A device for preparing a sample slide, comprising:
a rectangular chassis;
a thermostatic block member for providing stable heat, provided in a strip-like arrangement at an upper center part between a pair of side walls of the chassis;
a heat transferring member made from heat transferring fins arranged at the bottom surface of the thermostatic block member and to stand in a water bath as a part of a heating member, the heat transferring member providing stable heat from water at an appropriate temperature stored in the water bath to a glass slide via the thermostatic block;
a top board provided with a temperature sensor and a humidity sensor for measuring dryness in an enclosed space for spreading a metaphase analyte on the glass slide, the top board integrally formed adjacent to the side walls of the chassis so as to fill in the gap between the thermostatic block and the chassis formed on one side of the thermostatic block member;
a first humidity adjusting fin that can be opened and closed, provided at the gap between the thermostatic block and the chassis formed on the other side of the thermostatic block member;
a spreading space cover including surrounding walls and ceiling which form an enclosed space with the thermostatic block member, the top board and the first humidity adjusting fin, the spreading space cover provided with a second humidity adjusting fin that allows communication between inside and outside the sample slide preparing device and a drop pipette for dropping a cell-floating fluid as an analyte on a glass slide mounted on the thermostatic block; and
a heating unit including the water bath for storing water at an appropriate temperature for immersing a part of the heat transferring member and a lower part of the entire circumference of the chassis, and a heater for heating the water stored in the water bath to the appropriate temperature.

8. A device for preparing a sample slide according to claim 6 or 7, further comprising:
a centrifuge including a centrifuge rotating mechanism, tubes held by a plurality of oscillating buckets arranged on the centrifuge rotating mechanism, one or more supplying pipettes for injecting a liquid reagent into the tubes, a delivery pump for delivering a liquid from a reagent bottle to the supplying pipette, a discharge pipette for discharging a liquid from the tubes, a discharge pump for suctioning drainage from the discharge pipette and discharging it to a drainage tank, and an agitating mechanism having an up-down agitating mechanism for holding each tube and moving it up and down and a driving unit for axially rotating the oscillating buckets in clockwise and anticlockwise directions; and
a XYZ-direction movable pipetting mechanism that allows the analyte harvested by using the centrifuge to be dropped on a glass slide mounted on the thermostatic block.

9. A device for preparing a sample slide according to claim 6 or 7, further comprising:
a saturated moisture value detecting unit for outputting a saturated moisture value at a temperature detected by the temperature sensor by referring to a saturated moisture value in the same condition stored in a memory;
a dryness calculating unit for outputting dryness determined according to the following equation using the saturated moisture value determined by the saturated moisture value detecting unit and an actual absolute humidity measured by the humidity sensor:
Dryness (Idry)=Saturated moisture (Ws)−Absolute humidity (AbsH).

10. A device for preparing a sample slide according to claim 8, further comprising:
a saturated moisture value detecting unit for outputting a saturated moisture value at a temperature detected by the temperature sensor by referring to a saturated moisture value in the same condition stored in a memory;
a dryness calculating unit for outputting dryness determined according to the following equation using the saturated moisture value determined by the saturated moisture value detecting unit and an actual absolute humidity measured by the humidity sensor:
Dryness (Idry)=Saturated moisture (Ws)−Absolute humidity (AbsH).
